(19) United States
(12) Patent Application Publication
(10) Pub. No.: US 2004/0185339 A1
(43) Pub. Date: Sep. 23, 2004

(54) Ultra safe lead acid battery cell

(76) Inventor: William E. M. Jones, Freeport (BS)

Correspondence Address: SYNNESTVEDT & LECHNER, LLP, 2600 ARAMARK TOWER, 1101 MARKET STREET, PHILADELPHIA, PA, 191072950

(21) Appl. No.: 10/760,635

(22) Filed: Jan. 20, 2004

Related U.S. Application Data
(60) Provisional application No. 60/441,113, filed on Jan. 17, 2003.

(51) Int. Cl. H01M 2/02; H01M 2/12; H01M 10/50; H01M 2/04

(52) U.S. Cl. 429/177; 429/53; 429/82; 429/120

(57) ABSTRACT

A lead acid battery cell having at least two containments, an inner or first containment and an outer or second containment around the inner containment. The inner containment contains the electrolyte. The outer containment is leak proof in its upright position in that it can hold all electrolyte if the inner containment is breached. The outer containment is also fire-proof and explosion proof.

### RELATED APPLICATION

This application is based on and claims the benefit of U.S. Provisional Application No. 60/441,113, filed Jan. 17, 2003, and which is hereby incorporated by reference herein.

### FIELD OF THE INVENTION

The present invention relates to lead acid battery cells, and more particularly to an improved design making such cells fire-proof, spill-proof and explosion-proof.

### BACKGROUND OF THE INVENTION

Lead-acid standby batteries used for backup power for critical applications such as telecommunication systems, computer networks, military equipment, and nuclear reactor shut-down systems are vulnerable to damage from fires and explosions. Such accidents may not only cause local damage to the battery, which may result in acid spillage, but also risk shutdown of the systems that the battery is supposed to protect.

One key problem is the potential for fires. The containers and covers of conventional lead-acid cells and block batteries are typically made from plastic of one kind or another. Standby flooded cells commonly use transparent containers made of polystyrene, ABS, polycarbonate or PVC which permit visual inspection of the interior of the cell during service. The newer type “sealed” VRLA (valve regulated lead acid) cells commonly use opaque polypropylene or ABS containers. Some of these plastics, like polycarbonate and PVC are considered to be intrinsically “flame retardant” whereas others like polypropylene, must be modified with flame retardant additives.

The term “flame-retardant,” as used in the industry, means only that the plastic, once ignited by an external flame, is self-extinguishing in a normal air environment. However, this applies only if the external flame is removed after ignition. In the presence of a continuing fire, these plastics can continue to burn, some giving off acrid and toxic smoke. For example, a commonly used halogenated compound used to make polypropylene flame-retardant can produce poisonous dioxins during combustion. Plastic containers, therefore, even flame-retardant ones, can actually exacerbate the damage caused by other fires and be a direct danger to personnel and property.

Plastics are believed to constitute a far greater fire risk than is generally recognized by the battery industry. Fire experts, on the other hand, are acutely aware of the dangers. For example, the following concerns have been expressed:

Small scale tests conducted in the past were used to indicate that certain plastics are “self-extinguishing” or “non-burning” and, presumably, safe for use. Nevertheless, in real-life situations, the same materials have shown flash-burning characteristics.

When plastics and their constituent modifying agents, including flame-retardant additives, burn they can produce a wide variety of noxious and toxic by-products.

Claims for flame resistance have little meaning beyond the test method which was used to evaluate fire performance.

Test methods which in the past have been adequate to indicate the relative hazard of materials under actual use conditions, have failed to predict the fire behavior of some plastics. Of principal concern has been fire behavior which poses unusual hazards to life and property, including ignitability and rate of burning.

Although plastics tend to have a higher ignition temperature than wood and other cellulosic products, some plastics are easily ignited with a small flame and burn vigorously. Very high surface flame-speed has been reported up to 10 times the rate of flame spread across most wood surfaces.

The burning of some plastics is characterized by the rapid generation of large amounts of dense, sooty, black smoke. Chemicals added to inhibit flammability (i.e.: “flame retardants”) may increase smoke production.

Smoke generation will be worse with plastics containing aromatic monomers, like styrene, for example.

Depending on the plastic and the particular fire conditions, highly toxic gases such as hydrogen cyanide, hydrogen chloride and phosgene may also be evolved.

PVC polymers are especially difficult with respect to hydrogen chloride.

Thermoplastics tend to melt and flow when heated. In a fire situation, this characteristic may produce flaming and tar-like dripping which is difficult to extinguish and which may start secondary fires.

Research continues to try and improve the fire resistance of plastics but, any material that is easy to form by injection molding must have a relatively low melting point. Thus, these plastics can never achieve the intrinsic non-flammability rating of, for instance, steel or ceramic. Therefore, a great improvement in battery design would be a cell enclosure that was truly non-flammable under all reasonable conditions.

Another problem is battery acid spillage. Traditional cell designs, called “flooded” cells, add a further risk in that their sulfuric acid electrolyte can spill on to the floor of a battery room, causing damage to the building and to nearby equipment. Large cells can contain several gallons of acid and there may be hundreds of these cells in the same room. Sometimes these batteries may be located high up in an office building which makes the potential damage even more serious. Further, these cells, which can weigh hundreds of pounds, can be broken simply by dropping them on the floor during installation or removal, or there may be a disturbance such as an earthquake or act of war which could damage the cells during their normal operation. Generally, therefore, flooded batteries are required to be provided with an expensive acid containment and neutralization arrangement on the floor of the battery room.

A further concern is that the very act of extinguishing the fire may damage the plastic container of a lead-acid. For example, the use of CO₂ fire extinguishing methods can cause substantial thermal shock and will crack battery jars and/or covers.

Therefore, a great improvement in battery design would be a cell that had its own built-in containment such that, in any reasonable event or accident, the acid would be contained inside and not permitted to flow into the environment. Further improvements can be had if this containment could survive impacts and shock from all reasonable causes.

Another problem is the potential for battery explosions. Fire is not the only hazard that cell containers must face. Explosions of oxygen/hydrogen gases inside a cell during charging has been a well known hazard. The cell containers and covers presently used are too fragile to contain an internal cell explosion and the normal consequence of a cell explosion. For example, the shattering of the cell container or cover into high velocity shards can injure unprotected personnel. In addition, a sulfuric acid mist may be sprayed into the air which is very damaging to lungs. Unfortunately, battery explosions happen quite often, and the dangerous consequences of such have become accepted.

Therefore, a great improvement in lead-acid cell design would be a cell that could contain an oxygen/hydrogen explosion from within and, preferably, survive well enough to continue supporting its electrical load.

Accordingly, a battery cell that is fire-proof, spill-proof, and explosion-proof is desired.

### SUMMARY OF THE INVENTION

The present invention provides a lead acid battery cell having an electrolyte that includes sulfuric acid. The battery cell has a first or inner containment, the electrolyte being contained within this first containment. Positive and negative electrodes are provided within the first containment and in contact with the electrolyte. Positive and negative posts are electrically connected to respective positive and negative electrodes and extend through the first containment. Within the first containment is a gas space in which oxygen and hydrogen gasses may collect. The first containment is disposed within in a second containment, the second containment being leak proof in that when in its upright position it can hold the entire amount of electrolyte should the first containment leak. The outer containment can also be made fire-proof. One preferred configuration has an inner containment made of plastic, an outer containment made of steel. The cell is explosion-proof, i.e. the second containment has sufficient strength so as not to rupture in the event of an explosion of gasses within the first containment. The required strength for making the cell explosion proof can be reduced with other explosion proofing means such as minimizing the gas space in the cell which may minimize or possibly even eliminate the risk of an explosion.

Means for venting gas from within the first containment is provided. With flooded cells, the vent could be a suitably sized hole through the first and second containments, or a vent plug sealably connected to an opening in the inner containment and extending through the outer containment. With VRLA cells, the vent plug may include a pressure relief valve. Vent plugs may also include a catalyst to recombine the hydrogen and oxygen gasses.

The dimensions may be configured so that the inner containment fits within the outer containment so as to provide a gap between the sides, and/or bottom, and/or top of the two containments. This gap can be filled with insulation to provide added thermal protection to the inner containment. As the outer containment provides superior strength and can support the inner containment, the inner containment can be made of a less expensive, structurally weaker plastic or other material as compared with the plastics used with presently known cells.

Thus it is seen that a cell much safer than existing cells is provided, one that is leak-proof, fire-proof, and explosion proof.

### BRIEF DESCRIPTION OF THE DRAWINGS

The foregoing summary, as well as the following detailed description will be better understood when read in conjunction with the figures appended hereto. For the purpose of illustrating the invention, there is shown in the drawings several preferred embodiments. It is understood, however, that this invention is not limited to the precise arrangement and instrumentalities shown.

FIG. 1 is a partial schematic view of a battery cell in accordance with the present invention;

FIG. 2 is a schematic view of a battery cell in accordance with a second embodiment of the present invention;

FIG. 3 is a partial schematic view of a battery cell in accordance with a third embodiment of the present invention;

FIG. 4 is a partial schematic view of a battery cell in accordance with a fourth embodiment of the present invention;

FIG. 5 is a side view of a battery cell in accordance with the present invention showing various features; and

FIG. 6 schematic view of a battery set up in accordance with the present invention that is earthquake resistant.

### DETAILED DESCRIPTION OF THE PREFERRED EMBODIMENTS

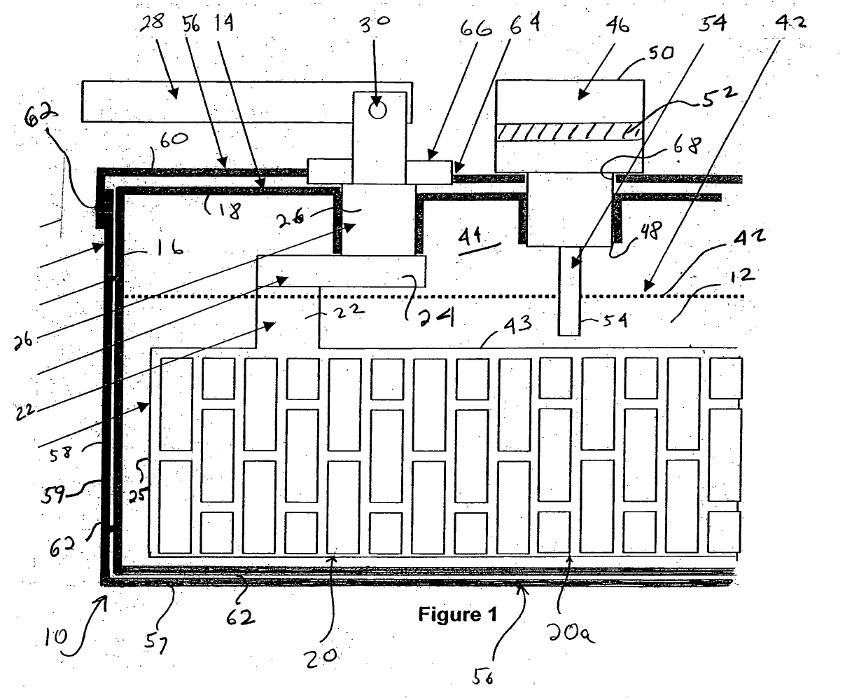

Shown in FIG. 1 is a schematic partial view of an embodiment of the present invention as it applies to a flooded lead-acid cell. It is understood, however, that the following description applies equally to other type cells such as special VRLA (valve regulated lead acid) cells, referred to herein as “Semi-flooded Cells” as described in U.S. Pat. No. 6,274,2, the disclosure of which is hereby incorporated by reference herein, and even more typical VRLA cells having a gel electrolyte (e.g., “Gel” cell) or other type (e.g., “AGM” cell).

With reference to FIG. 1, a single cell lead acid unit 10 has a liquid electrolyte 12 that includes sulfuric acid. A first or inner containment 14 has a container 16 and a cover 18 similar to typical battery cell containers as used for lead acid cells, and which are attachable to one another, such as by heat-sealing or bonding with epoxy resins or other adhesives as known in the art. The container 16 is liquid tight in that it can hold the full volume of electrolyte 12 within without leakage when in a normal upright position.

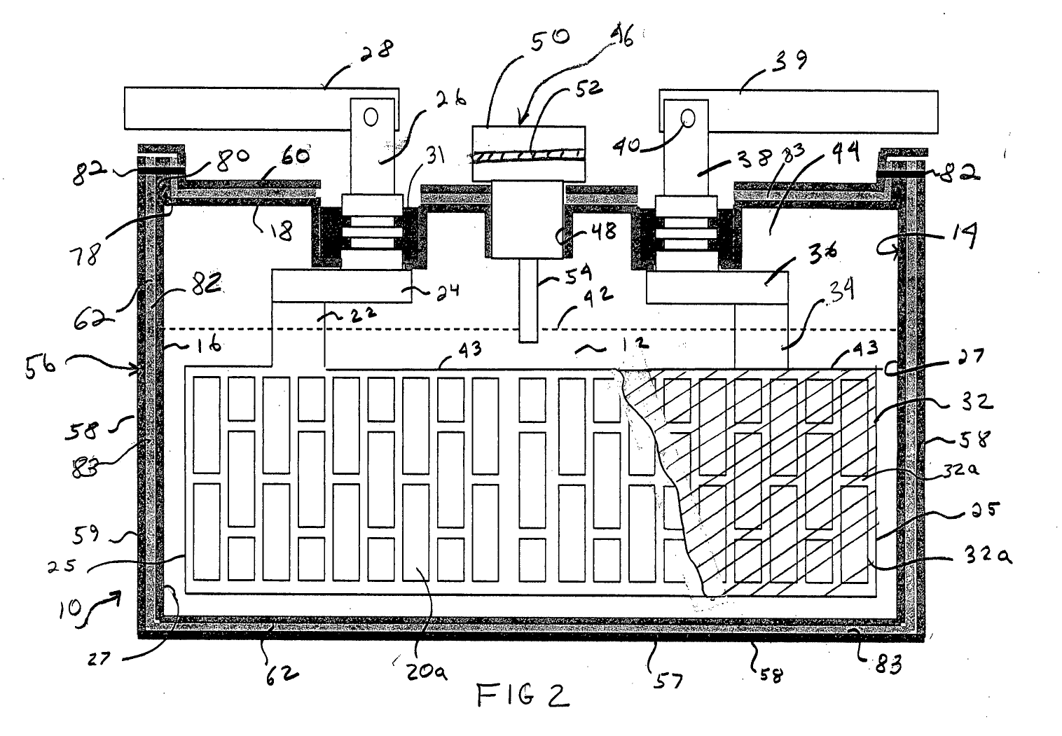

A positive electrode 20 in the form of a positive plate 20a is in contact with the electrolyte 12, it being fully immersed in the electrolyte 12 in this embodiment. There can be multiple such plates 20a in a typical cell 10 as is known, each such plate having a lug 22 connecting to a common bus bar 24 that electrically connects multiple positive plates 20a to a positive post 26. The post 26 extends sealingly through the cover 18 to the outside of the cell 10, for electrically connecting the cell 10 to other cells 10 through an intercell connector 28, connected to the post 26 by bolt 30, and to the load to be powered by the cell. The post 26 extends sealingly through the cover 18 such by means of epoxy 31 or compressed rubber gland or any other seal method known in the art (see, e.g., FIG. 2). In practice, there can be more than one post to lessen electrical losses.

A negative electrode 32, in the form of a negative plate 32a, which is substantially a mirror image of the positive electrode 20, is provided in contact with the electrolyte 12 (see FIG. 2). A negative plate 32a looking similar to the positive plate is positioned next to the positive plate (shown just behind the partially removed section of it in the FIG. 2 as is known in the art). There can be multiple such negative plates in a typical cell 10 alternating and in close proximity to the positive plates 20a with a separator in between each positive and negative plate, each such negative plate having a lug 34 connecting to a common bus bar 36 that electrically connects the multiple negative plates a to a negative post 38. The post 38 extends outside the cell 10 for electrically connecting the cell 10 to other cells 10 through an intercell connector 39 connected to the post by a bolt 40 and to the item to be powered by the cell.

In a flooded cell 10 as shown in FIG. 1, the electrolyte level 42 is substantially above the top 43 of the positive and negative plates to allow for water loss in service. In a Semi-flooded cell, the electrolyte level is below the top 43 of the plates.

A gas space 44 above the positive and negative plates may contain an explosive mixture of hydrogen and oxygen gasses generated when the cell is on a high-rate charge. These gases are allowed to escape to the atmosphere through a vent 46 as further discussed below. In Valve Regulated Lead-Acid cells (VRLA), including the Semi-flooded cell, the vent is always equipped with a pressure-relief or check valve to prevent oxygen from entering the cell and discharging the exposed negative plates. In flooded cells, however, the negative plates are submerged in electrolyte 12 and protected against oxidation, so no special valves are required for normal operation.

The vent 46 allows excess gas to exit the interior of the cell 10 (e.g. the gas space 44) and pass to the atmosphere. This is essentially a passage from the gas space 44 inside the first containment 14 to the atmosphere of sufficient size to allow gasses to exit the cell, and may have an adequate opening size to permit some release of pressure in the event of an explosion within the cell. However, it is preferred that an explosion be contained completely within the cell 10 with means as discussed further below.

In the illustrated embodiment of FIG. 1, the vent 46 includes a vent opening 48 through the cover 18 sealed with a vent plug 50 through which the gasses can exit the cell 10 to the atmosphere. The vent plug 50 preferably includes a flame arrestor 52, such as a porous ceramic material, to prevent a flame from entering the first containment 14, such vent plugs being well known in the art. In a VRLA type cell, the vent plug 50 may also include a pressure relief valve that opens to release gasses from the gas space within the first containment 14 and thereby lower the pressure only when a predetermined pressure within the cell is reached, e.g., Bunsen type valve, spring biased valve or other type pressure relief valve as known in the art. Vent devices can also include a catalyst positioned to be in contact with the gasses in the gas space for recombining the oxygen and hydrogen gasses to vapor (the catalyst can also be provided in the gas space separate from the vent plug). Such vent devices are known in the art, see, e.g., WIPO Patent Publication 99/4179 to Jones et al. and U.S. Pat. No. 4,002,496, both of which are hereby incorporated herein by reference. As a further improvement, flooded cells could be equipped with pressure relief valves having a setting to open at a pressure higher than the head pressure of the electrolyte 12 in the cell when in an inverted position. This would prevent spillage if the cell 10 tipped over during installation or other type of accident even if the cell were turned upside down.

An electronic level indicator 54 can be provided in the vent or in a separate sealed hole through the first containment 14 to indicate when the cell needs water; this compensating for the lack of transparency of the second containment. A suitable level indicator is of the type shown in U.S. Pat. No. 5,936,382.

As discussed above, in the illustrated embodiment, the container 16 and cover 18, taken together, form the first containment 14. This first containment 14 does not need to be non-flammable or of high strength because it is disposed within and almost completely enveloped by a close-fitting second or outer containment 56 consisting of container 58 (having a bottom 57 and sides 59) and cover 60, and which is preferably stronger than the first containment 14 and fire-proof as discussed below. The first containment 14 can be made of materials similar to those of which presently known containers for lead acid cells are made from, such as suitable plastics, and manufactured in a similar manner. In the illustrated embodiment, the first containment could simply be an existing known type of cell, complete with its plastic container, which is placed inside a second containment 56 in accordance with this invention.

The second containment 56, i.e., the container 58 and cover 60, is preferably fire-proof in that it will not support combustion in a typical fire. It should also be of sufficient strength so as not to rupture in the event of an explosion of the gasses within the cell 10, i.e., within the first containment 14. The second containment 56 is also preferably leak proof in that when in its upright position, it is leak tight and has no holes through which liquid can escape by gravity so as to be able to hold the full volume of electrolyte 12 within the cell 10 should the first containment 14 leak. (The cover 60 is not necessarily leak proof). Suitable materials that provide such qualities include steel as illustrated, e.g., 1/16 to ⅛ inch mild steel depending on the size of the cell 10. While steel is a preferred material for the second containment, other suitable materials may be used, e.g., other metals, alloys, glass, ceramic, high temperature plastics, or other suitably strong materials suitably coated or treated to provide the desired qualities.

The steel containment 56 is preferably made with a welded construction but may be bolted, riveted, bonded or made with any other suitably strong technique. The steel cover 60 and the steel container 58 are joined together by suitably strong attachment means such as a series of pins 62 or bolts or interlocking tabs or even continuous welds, etc. The attachment means used should be able to resist the forces due to an explosion, e.g., an internal pressure from 100 psi to 300 psi or other pressure depending of the design of the cell and the expected forces from an explosion. For example, inclusion of explosion attenuating features such as foam as discussed below may lower the pressure that the containment may be exposed to from an explosion. The steel can be coated with an insulating coating such as vitreous enamel or high temperature paint at least on the outside surface.

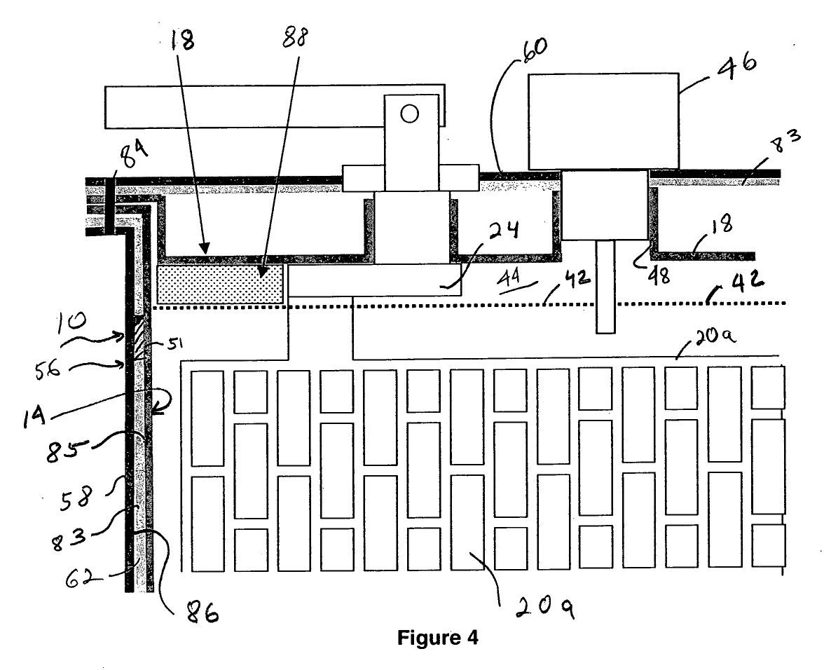

The container 58 and cover 60 of the second containment may be assembled with or without a gap 62 between them and the first containment 14, depending on the design. A gap up to about 0.25 inches is believed acceptable depending on the particular design, although a larger gap may be used in special circumstances. The gap 62 can have ribs therein, along the sides, bottom, and top of the containments to maintain the gap and keep the two containments positioned relative to one another (the ribs could preferably be formed as part of the outer surface of the first containment 14 as further discussed below with reference to FIG. 4). The cell posts 26, 38, sealed against the first containment 14, rise through the steel cover 60 of the second containment 56 through annular openings 64 that are large enough to avoid short circuits (by not contacting the second containment 56), but small enough to limit access to the first containment 14 within, here the internal plastic, of an external flame or to permit fragments of plastic from within to escape in an explosion. A gap between the post and containment between about 0.1 and 0.25 inches is believed acceptable, although larger gaps may be used depending on the design. The annular openings 64 may be covered or closed by an insulating collar 66 made with a suitable fire-proof material such as a ceramic, thereby virtually sealing the flammable plastic components inside the steel second containment 56. The vent plug 50, which is sealingly connected to the first containment 14 as known in the art, extends through on opening 68 in the second containment 56, although, since typical vent plugs are made of a non-conducting material such as plastics, the tolerances between the vent plug and the side of the opening can be kept to a minimum. The overall result is a cell that has its own acid containment, is explosion proof and will not support external combustion, a major improvement in battery safety.

Where there is a gap 62 between the first and second containments as in the illustrated embodiment, the gap 62 can be filled with a suitable high temperature insulating material such as glass wool, alumina flock, porous ceramic sheet, or asbestos as is further discussed below with reference to FIG. 2. This would be helpful in a very severe fire. For example, with intense thermal radiation from an external fire burning on the outside of the steel second containment, the inside of the cell would soon get hot due to heat conduction through the metal and could char or destroy the inner containment. Insulation between the two containments would provide additional time for use of the battery such as for delaying shutdown of the load supported by the battery before eventually failing to a safe condition. As another option, a non-radiating finish can be added to the inner surface of the second containment to minimize transfer by radiation.

As another feature, the gap 62, or gaps 62 designed into compartments, could be filled with a cooling fluid and connected to an external cooling source or chiller. This is more of an economic feature. The life of cells 10 cooled by 10 degrees Celsius can be approximately doubled. That is, a 10 year cell could last 20 years in service, saving a great deal in capital and replacement cost. The float current would also be reduced which may pay for the energy required to cool the fluid.

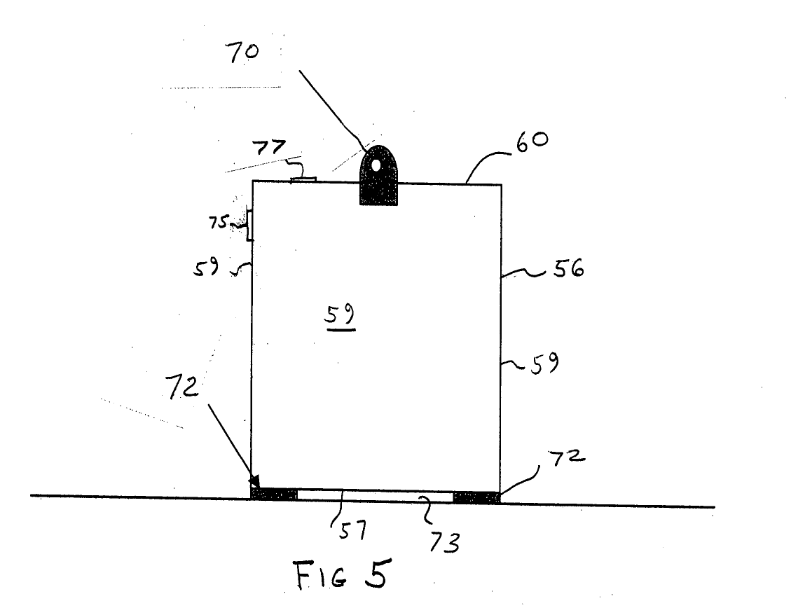

Due to its high strength, the second containment 56 may be provided with a variety of features not possible with the conventional plastic-enclosed cell. For example, where the second containment 56 is made of steel as illustrated if FIG. 5, it is possible to have special lifting eyes 70, e.g., lugs, that attach to the steel to facilitate lifting and installation of the cell 10. The second containment 56 may have feet 72 to raise the cell 10 that provide both a longer path for stray currents and also a space 73 for the forks of a fork-lift truck. It may be treated with a hydrophobic coating on the outside surface, e.g., Teflon treatments, wax, various polymer coatings etc., to minimize possible wetting of the surface with electrolyte films, which can cause stray currents, without fear of crazing the container. It may be provided with a small window 75 through the steel second containment made, for example, from Pyrex glass or a small opening hatch, to permit visual inspection of the acid level without seriously compromising the fire-proof or spill proof aspect of the design. It may be provided with small, sealable access port 77 in the cover for reading acid specific gravities as is common to conventional cells.

A special and useful case of the embodiment shown in FIG. 1 is one whereby the plastic used to make the internal first containment 14 is changed from the expensive materials presently required for structural rigidity in cell containers to a lower-cost plastic liner that does not have to be rigid; the outer steel containment 56 now providing the required rigidity. In other words, an expensive injection-molded PVC or polycarbonate container/cover typical of present containers may be replaced with a less expensive blow-molded or rota-molded polyethylene one for a fraction of the cost and with far lower tooling cost. Moreover, the inner containment 14 may be no more than an acid resistant coating on the steel containment 56 itself made, for example, by spraying a plastisol material or the like.

In the embodiment shown in FIG. 1, the plastic container and cover of the first containment are not physically attached to the steel second containment 56, so the final assembly could consist of simply placing a conventional cell inside the steel outer containment 56. Thus FIG. 1 illustrates a simple embodiment of the present invention which may involve no more than placing an existing conventional cell (containment 14), complete with its present plastic container into a separate fire-proof, spill-proof and explosion-proof second containment 56, preferably made of coated steel. It is a practical solution in the sense that it could be immediately put into production by a battery manufacturer without the cost involved in changing current cell designs.

The embodiment shown in FIG. 1 is believed to be more suitable for smaller cells since, for very large cells, such as large sealed VRLA cells, making a good, hydrogen-tight seal between a large plastic container 16 and cover 18 is a difficult process. So while the design shown in FIG. 1 is believed to suffice for large flooded cells where small leaks in the seal in the first containment constitute no real problem, it may present difficulty for large VRLA cells where small leaks inevitably result in self-discharge to the cell. This drawback is overcome in other embodiments described below.

Shown in FIG. 2 is an embodiment of the present invention that is optimized for manufacture of both large VRLA cells and large flooded cells. Many of the elements are the same as those of FIG. 1, with like elements having the same reference number. Here, unlike the embodiment of FIG. 1, the inner plastic container 16 and cover 18 of the first containment 14 are not joined together independently before placement into the second containment 56. Rather, they are clamped together with the second containment 56 during assembly to make a gas-tight seal between the container 16 and cover 18 along the sealing surfaces, i.e., the top section of inner face 78 of the container 16 and the side inner face section 80 of the cover 18 as shown. Here, the means for clamping the two together is by a number of screws 82 as shown, other means including rivets, welding, etc. The additional use of cements or grouts on the sealing surfaces to seal the cover and container 16, 18 of the first (inner) containment 14 makes possible a low-cost, gasket-type seal that is robust and leak-free, and believed to be especially suitable for VRLA applications. This design also eliminates the expense of plastic heat-sealing machinery and the labor in maintaining the same typically involved with attaching a plastic cell container and cover.

The sealing surfaces 78, 80 of the plastic container 16 and cover 18 may be treated to improve the final bond between them. For example, in the case of polyethylene, a preferred commercial choice for the plastic container and cover, the sealing surfaces can be treated by flaming or by plasma, as is well known in the art, to modify their surface energies. This permits an otherwise un-bondable material like polyethylene to bond well with compounds such as epoxy and to provide a hydrogen-tight seal.

This “clamped seal” permits two different materials to be used for the container 16 and cover 18 if required or desired. For example, a flexible, rubber-like cover 18 may be used that will deform readily in an explosion, without fracturing, and recover its shape afterwards. At the same time, the container 16 could be made of some other plastic.

To improve the survivability of the cell in a serious fire, the design shown in FIG. 2 may be improved further by inserting high-temperature insulation 83 in the gap 62 between the plastic first containment 14 and the steel second containment 56, both container 58 and cover 60, that is, above, below and all around the plastic inner containment 14 as far as is practicable. This insulation 83 may consist of sheets of glass fiber, ceramic foam, or asbestos substitute, pellets of vermiculite, sand; castable refractory and so on. In the case of a fire, the insulation will delay heat damage to the cell plastic components and permit more time to shut down the protected system. An air gap 62 without insulation can provide considerable insulation, especially if the inside surfaces of the steel second containment 56 (container and cover) are designed to minimize transfer of heat by radiation by providing reflective or shiny surfaces and other techniques that are well known.

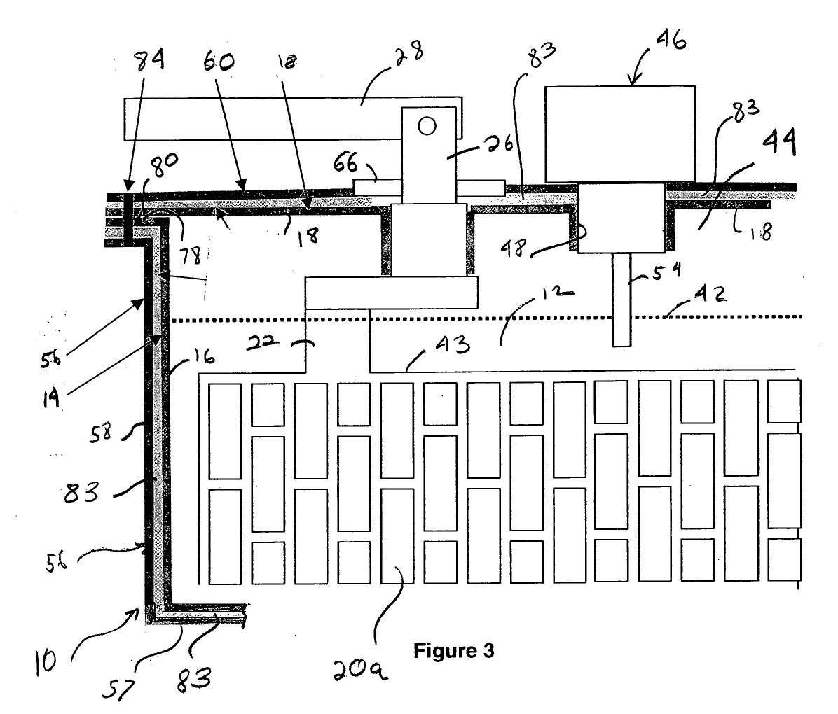

An alternative clamping arrangement for the sealing area is shown in FIG. 3 where flange like sealing surface areas 78 and 80 are in the horizontal plane instead of the vertical plane as shown in FIG. 2. Here, the steel second container 58 and the plastic inner container 16 have horizontally flanged top edges to which the horizontal steel cover 60 and inner plastic cover 18 are attached by bolts 84. As before, an intermediate insulating layer 82 may or may not be inserted between the two containments 14, 56. This horizontal flange arrangement has the benefit that the cell 10 can be lifted by the resulting flanges or bolted through the flanges into an earthquake rack as discussed below. Also, the sealing surfaces 78, 80, being horizontal, are believed to require less critical tolerances. In general, the clamped seal surface may be in any plane between horizontal and vertical.

With reference to FIG. 4, illustrated is another embodiment of the present invention intended to minimize or reduce the force of any possible explosion within the first containment 14 of the cell 10 due to the oxygen and hydrogen gasses within. Here, this is done by reducing the volume of these explosive gasses, e.g., reducing the volume of the gas space 44. To reduce the total volume of explosive gas available in the cell at any one time, the cover 18, here made of plastic, is formed in a shape that follows the internal contours of the internal elements, e.g., the plates 20a, 32a, and bus bars 24, 36 to displace as much gas space as possible. That is, it projects downwards into the cell 10 as close to the acid level 42 as possible as shown, allowing for the acid level 42 to change during boost charging of the cell. This plastic cover 18 is preferably made from a flexible material to allow sufficient deflection in the event of an explosion and thereby allow the gas to expand and reduce the maximum pressure in the cell. To illustrate, an oxygen/hydrogen explosion inside a rigid vessel can raise the pressure within a few milliseconds to about 300 psi. If a cover can deflect upwards in an explosion so as to increase the gas expansion volume by a factor of three, the peak pressure will be reduced to 100 psi which is easier to contain. In a real explosion, the steel containment may also bulge appreciably which will further limit the rise in pressure. Yet more expansion space may be provided with a gap 62 between the inner and outer containers 14, 56, with ribs along the outer surface 85 of the inner containment 14 for supporting the inner container 16 against the inside surface 86 of the outer containment 56. (A partial rib 51 being formed as part of the inner containment 14 is illustrated in FIG. 4, such ribs extending vertically and/or horizontally, preferably over the full or most of the height of the containment 14). All these actions will attenuate the force of the explosion.

Further improvement are believed possible with the use of slabs of porous plastic foam 88 or other porous materials inside the gas space 44 of the cell to reduce the pressure rise even further in the event of an explosion. As much of the gas space 44 as possible should be occupied since the gas within the foam will not explode if ignited. This principle is disclosed in U.S. Pat. Nos. 2,341,382 and 5,178,973, which are hereby incorporated by reference herein. Preferably, the porous material should be carefully precut or otherwise pre-shaped into slabs that precisely match the individual cell design to properly displace as much gas space 44 as possible. Chopped lumps of foam or bulk material that is not designed for a particular cell is not as preferable.

To illustrate the practical effectiveness of plastic foam in explosion mitigation the following experiment was conducted: A plastic box was filled with oxygen/hydrogen gas at atmospheric pressure and the gas ignited. The box exploded violently. Next, a similar box was packed with a close-fitting pad of soft polyurethane foam having a pore size less than 1/100^{th} of an inch and then also filled with oxygen/hydrogen gas. Since the foam was only 5% solid and 95% space, the box contained almost the same volume of gas as the first box. When this gas was ignited, there was no explosion; the foam having quenched it before it began. On the other hand, a similar test using foam with pores 1/60^{th} of an inch produced an explosion that shattered the box. Thus it is believed that a pore size of 1/100^{th} of an inch or less is known to be safe. This feature, in conjunction with the steel second containment and molded, flexible gas-displacing cover 18 shown in FIG. 4, should radically reduce the dangers of battery explosions.

While the plastic foam discussed above is of the open cell type, it is believed that closed cell foam may also work to displace the gas space and compress in the event of an explosion to provide expansion space and reduce peak pressures.

The present invention as illustrated in the various embodiments above thus provides numerous advantages and features. One such advantage is the possibility to make cells earthquake proof, or at least resistant. For example, the steel second containment 56 may be attached directly and strongly, for example by bolts, to a rack or structure that is made earthquake proof by bolting it to the floor of the building. This concept may be sufficient for most moderate earthquakes.

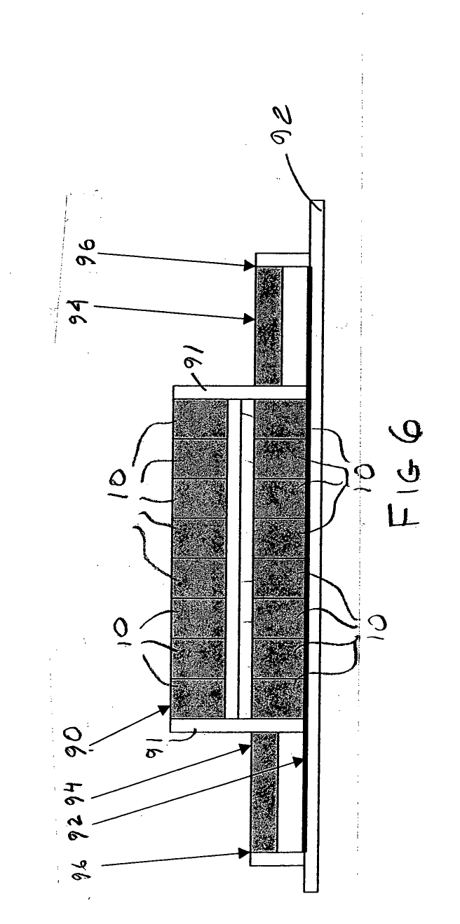

For severe earthquakes, however, and for the more critical applications, the present invention permits a much higher level of technology to be applied as is now described with reference to FIG. 6. As in the case of conventional batteries, the entire battery, consisting of many cells 10 is bolted together into a single, unitized mass 90, here two rows of eight cells connected together held on steel racks 91. Each cell 10 may weigh up to several hundred pounds. The battery mass 90 is not bolted rigidly to the floor 92, e.g., a battery room, but rather attached movably to the floor 92. That is, it is provided with 2 degrees of freedom to slide horizontally, either fore and aft or from side to side or both, relative to the floor 92 itself. However, this horizontal movement is limited and controlled by a spring and damper arrangement 94 (shown schematically) attached to strong stanchions 96 so that the natural frequency of vibration of the battery mass is significantly different from the natural frequency of the building and also highly damped as is well known in the art of vibration engineering. The frequency of vibration of the battery mass is controlled largely by the value of the mass and spring stiffness. The springs may, for example, be coiled springs, air springs, or leaf springs. The dampers may be hydraulic or friction which may come from a floor specifically prepared to act as the damping element as shown. The result is a battery that will stay substantially unmoved, or be far less disturbed, in a severe earthquake even as the floor moves to and fro beneath it.

Advantages and features are readily seen from the description above. The invention improves the safety of the stationary lead-acid cell, particularly the flooded variety that use liquid electrolyte, by enclosing it almost completely inside a strong, substantially liquid-tight, enclosure made, for example, of steel with an insulating coating such as vitreous enamel or high temperature paint. Thereby, the cell will have at least two containments, the first containment in the form of an inner, preferably plastic, containment and a second containment in the form of an outer armored, preferably steel, enclosure.

The cell becomes fire proof. The armored second containment of the present invention presents little or no flammable materials to support an advancing fire, making the cell not just “flame retardant”, as present plastic cells questionably claim to be, but fire-proof in that it will not support combustion in a typical fire. Cells might survive for some time and continue supporting the electrical load until deliberately shut down.

The cell becomes spill-proof. The steel second containment of the present invention is a substantially liquid-tight vessel which, in its upright position, has no open holes though which acid can escape by gravity.

The cell becomes explosion proof. The steel second containment of the cell may be made strong enough, by design, as discussed above, to contain any explosion caused by the oxygen/hydrogen gasses inside without producing shrapnel-like effects. A typical oxygen/hydrogen explosion can easily rupture a conventional plastic container but is not strong enough to rupture a steel enclosure that is designed expressly to resist the explosion. Moreover, the cell may often escape without any internal damage and can continue to protect the system that it was designed to service, thereby making the protected system itself more robust.

Elimination of cover crazing. A very common problem with plastic cell containers and covers, especially those made with amorphous polymers such as Polystyrene, ABS and Polycarbonate—and most flooded cells are made from these materials—has been their tendency to craze or crack under stress, especially in the presence of solvents or high temperatures. Typically, a cell cover may have built-in stresses from the molding process or may have stresses applied during cell assembly. If the cell is later cleaned with, for example, a household spray cleaner, it will crack at the points of high stress. Polyolefins such as propylene and polyethylene are not prone to stress cracking but they are generally less rigid and cannot be used in the construction of large free-standing cell containers. In the present invention, the steel second containment can provide all the stiffness necessary and the inner first containment may then be made from a polyolefin plastic because it no longer needs to be rigid. The result is a significant cost reduction as well as a quality improvement because stress cracking will essentially be a thing of the past.

Elimination of container cracking due to plate bucking. Plates are generally made of lead and are relatively soft and, when placed vertically inside a container, have to be supported with a horizontal force to prevent buckling. In flooded cells, this support must ultimately come from the rigid container walls which then are at risk of stress cracking. In the present invention, the steel second containment around the plastic inner liner takes the load and relieves the plastic. The steel second containment will not crack or craze under any realistic conditions, even if strong solvents were used to clean it or if CO₂ fire extinguishers were used on it.

Elimination of container cracking due to horizontal plate growth. The positive grids in lead-acid cells always grow in service. This is fundamental because a corrosion layer of PbO₂ builds up on the lead conductors and, being less dense than the base lead, expands and stretches the lead. This growth is exacerbated in standby batteries by the fact that traditional lead-antimony alloys, which have a relatively high tensile strength, have been largely replaced by pure lead and other soft alloys that have low tensile strength and stretch easily. Vertical plate growth has been accommodated in conventional cells by hanging the positive plates from the top of the cell and leaving space for the plates to grow downward. Horizontal growth has been accommodated simply by making the container wide enough (i.e., wasting space). However, in the present invention, the strong steel containment 56 can be used as an exoskeleton to provide resistance to plate growth from the outside of the container. That is, the plate can be allowed to grow at a normal rate until it touches the sides of the inner first containment; after this, it will, essentially stop growing. The stress that would be unbearable for plastic containers is easily borne by the steel outer containment 56. For example, in the present invention, with reference to FIG. 2, the side ends 25 of the positive and negative plates could initially be between 0 and 1/16 of an inch or even 0 and ¼ inch from the sides 27 of the first containment 14, much less than in present cells. The outer containment 56 could take the stress of the plate growth.

Safer lifting and carrying. A large standby cell in a plastic container is a heavy and difficult object to lift and install in tight spaces. Common practice is to lift a cell by putting a fabric belt or band under it and then hoisting it from above. This is an unstable and risky operation in that the cell can easily fall out of its banding. It also requires substantial vertical space which may not be available in some battery rooms. The strong steel second containment of the present invention eliminates these problems. The cell can be safely hoisted by dedicated lifting holes in, or lifting eyes attached to the steel second containment, or even lifted from underneath with a fork truck as discussed above. And even if the cell should fall, it would not spill acid.

Better structural strength. Cells in plastic containers have little intrinsic structural strength so they must be supported on separate racks of some kind. Many conventional racks are simple shelves with no protection against earthquakes. Racks made to withstand earthquakes are heavily braced but, again, the cells simply rest inside these racks and, if there are any clearances, they will be bumped around during tremors. The steel second containment 56 of the present invention, by contrast, is strong enough to become part of the structure itself. For example, the steel second containment 56 can bolt directly to a steel rack member, preventing any relative movement and bumping. The steel sides of the second containment can become a stressed member of the rack system to the point that no rack may be needed at all, just the cells and a few joining pieces.

Other advantages and features may be learned by practice of the invention.

What is claimed is:

1. An individual lead acid battery cell having an electrolyte that includes sulfuric acid, said battery cell comprising:
a first containment having a first container and a first cover, said electrolyte being contained within said first containment;
positive and negative electrodes within said first containment and in contact with said electrolyte;
positive and negative posts electrically connected to respective said positive and negative electrodes and extending through said first containment;
a gas space within said first containment in which oxygen and hydrogen gasses may collect; and
a second containment having a second container and a second cover, said first containment being disposed within said second containment, said second containment being leak proof in that when it is in its upright position it can hold all of said electrolyte should said first containment leak, and said second containment having sufficient strength so as not to rupture in the event of an explosion of said gasses within said first containment.

2. The cell of claim 1 wherein said second containment is fire proof.

3. The cell of claim 2 further comprising:
a vent device extending sealingly through said first containment and further through said second containment through which gas from said gas space can exit said cell.

4. The cell of claim 3 wherein said vent device comprises a pressure relief valve for allowing said gas to exit said cell only when a pressure of said gas exceeds a predetermined amount.

5. The cell of claim 2 wherein said cover of said second containment is a separate member connected to said second container.

6. The cell of claim 2 wherein said second containment includes holes through which said posts extend, said holes being larger than said posts so that said posts do not electrically contact said second containment.

7. The cell of claim 7 further comprising an electrically insulating material disposed in said holes to prevent electrical contact between said posts and said second containment.

8. The cell of claim 8 wherein said insulating material comprises an insulating collar.

9. The cell of claim 2 wherein an outside dimension of said first containment is smaller than an inside dimension of second containment so as to form a gap between said containments.

10. The cell of claim 10 wherein said gap is filled with an insulating material.

11. The cell of claim 2 wherein said first containment and said second containment are physically attached to one another.

12. The cell of claim 1 comprising a vent device extending sealingly through said first containment and further through said second containment, said vent device having a pressure relief valve for allowing fluid within the first containment to exit said cell only when a pressure of said fluid exceeds a predetermined amount, said fluid comprising any of said gas and said electrolyte.

13. The cell of claim 12 wherein said predetermined amount is no less than a head pressure of said electrolyte when said cell is inverted such that the head pressure is exerted against said pressure relief valve.

14. The cell of claim 1 further comprising a gap between at least portions of said first and second containments.

15. The cell of claim 1 further comprising insulation between said first and second containments.

16. The cell of claim 2 wherein said second containment is made of steel and said first containment of a plastic.

17. The cell of claim 1 wherein said covers of said first and second containments are attached as a unit to said containers of said first and second containments.

18. The cell of claim 1 comprising multiple said cells attached together to from a single mass of cells.

19. The cell of claim 1 further comprising;
a spring and damper configured for controlling any horizontal movement of said cell.

20. The cell of claim 1 further comprising a porous material disposed within said gas space capable of attenuating an explosion of the gasses within said gas space.

21. The cell of claim 1 wherein a cover of said inner containment is configured to minimize a volume of said gas space.

22. The cell of claim 1 further comprising:
a gap between said first and second containments, said gap receiving cooling fluid for cooling said cell.

23. An individual lead acid battery cell having an electrolyte that includes sulfuric acid, said battery cell comprising:
a first containment, said electrolyte being contained within said first containment;
positive and negative electrodes within said first containment and in contact with said electrolyte;
a gas space within said first containment in which oxygen and hydrogen gasses can collect; and
a second containment that is non-flammable, said first containment being disposed within said second containment, said second containment being leak proof in that when it is in its upright position it can hold all of said electrolyte should said first containment leak, and said second containment having sufficient strength so as not to rupture in the event of an explosion of said gasses within said first containment.

24. The cell of claim 23 wherein said first containment is made of plastic and said second containment is made of steel.

25. The cell of claim 24 further comprising a vent device extending through said first and second containments through which gas from said gas space can exit said cell, said vent being sealingly connected to said first containment.

26. The cell of claim 23 wherein said first containment includes a container and a cover, and said second containment includes a container and a cover, said covers of said first and second containments being attached as a unit to said containers of said first and second containments.

27. The cell of claim 26 wherein said covers of said first and second containments are clamped to said containers of said first and second containments.

28. The cell of claim 24 wherein said first containment comprises a container of one type of plastic, and a cover of another type of plastic.

29. The cell of claim 24 comprising at least one lifting eye attached to said second containment.

30. The cell of claim 23 further comprising a foam having cells for attenuating an explosion.

31. The cell of claim 30 having an open cell foam.

32. The cell of claim 30 having a closed cell foam.

33. An individual lead acid battery cell having an electrolyte that includes sulfuric acid, said battery cell comprising:
a first containment, said electrolyte being contained within said first containment;
positive and negative electrodes within said first containment and in contact with said electrolyte;
a gas space within said first containment in which oxygen and hydrogen gasses can collect;
a second containment that is non-flammable, said first containment being disposed within said second containment, said second containment being leak proof in that when it is in its upright position it can hold all of said electrolyte should said first containment leak; and
means for making said cell explosion proof.

34. The cell of claim 33 wherein said means for making said cell explosion proof comprises said second containment being of sufficient strength so as not to rupture in the event of an explosion of said gasses within said first containment.

35. The cell of claim 34 wherein said means for making said cell explosion proof includes minimizing said gas space so as to minimize a volume of gasses that can explode.

36. The cell of claim 34 wherein said means for making said cell explosion proof comprises an open or closed cell foam disposed in said gas space.

37. The cell of claim 23 wherein side ends of said positive and negative plates are positioned no more than about ¼ inch from a side of said first containment.
